(19) United States
(12) Patent Application Publication
(10) Pub. No.: US 2025/0360906 A1
(43) Pub. Date: Nov. 27, 2025

(54) METHOD FOR DETERMINING A FLOW RESISTANCE CHARACTERISTIC VARIABLE

(71) Applicant: ZF CV Systems Global GmbH, Bern (CH)

(72) Inventors: Joachim Pracht, Hannover (DE); Ulrich Brockmeyer, Gronau OT Banteln (DE)

(21) Appl. No.: 19/287,365

(22) Filed: Jul. 31, 2025

Related U.S. Application Data
(63) Continuation of application No. PCT/EP2024/050834, filed on Jan. 16, 2024.

(30) Foreign Application Priority Data
Jan. 31, 2023 (DE) 10 2023 102 237.7

(51) Int. Cl. B60T 17/22; B60T 13/68

(52) U.S. Cl. CPC B60T 17/221; B60T 13/683; B60T 2270/10; B60T 2270/88

(57) ABSTRACT

A method is for determining a flow resistance characteristic variable in a brake system with an axle modulator having a pressure sensor for determining a pressure value allocated to a pressure line; and, a service brake connected to the pressure line. The method includes determining a first pressure value via the pressure sensor while the axle modulator is connected to the service brake in a pressure-conducting manner and the axle modulator is brought into a pressure maintaining position; generating a pressure pulse in the pressure line at a first time; determining a second pressure value via the pressure sensor at a second time after generation of the pressure pulse; and, determining a flow resistance characteristic value for a flow path within the brake system wherein the generated pressure pulse propagates, depending on a change over time of the second pressure value with respect to the first pressure value.

### CROSS-REFERENCE TO RELATED APPLICATIONS

This application is a continuation application of international patent application PCT/EP2024/050834, filed Jan. 16, 2024, designating the United States and claiming priority from German application 10 2023 102 237.7, filed Jan. 31, 2023, and the entire content of both applications is incorporated herein by reference.

### TECHNICAL FIELD

The present disclosure relates to a method for determining a flow resistance characteristic variable in an electropneumatic braking system of a vehicle.

### BACKGROUND

In modern braking systems, the brakes of a vehicle can be controlled individually for each wheel or axle, wherein a specific brake pressure is applied to them. Brake pressure is usually provided via axle modulators, which use switchable valves to control brake pressure via compressed air lines to the brake cylinders or service brakes on the respective vehicle axle. On a front axle, for example, this control takes place axle by axle, that is, the brake pressure controlled by the front-axle axle modulator via a single pressure channel is controlled equally to both brake cylinders or service brakes on the front axle. On the rear axle, on the other hand, this control is usually carried out via multi-channel rear-axle axle modulators, wherein an individual brake pressure is controlled for each rear wheel.

ABS valves can also be arranged between the axle modulator and the respective brake cylinders or service brakes, which in the case of ABS control can interrupt the pneumatic connection between the respective axle modulator and the respective brake cylinder at least briefly in order to maintain or reduce the brake pressure applied to the respective brake cylinder and thus prevent the respective wheel from locking. Typically, ABS valves are arranged on the front axle between the front-axle axle modulator and the respective brake cylinders on the front wheels, whereas the ABS function is already implemented in a multi-channel rear-axle axle modulator, so that additional ABS valves can be dispensed with.

A pressure sensor integrated in the respective axle modulator can be used to monitor the brake pressures emitted by the pressure modulator into the respective pressure line, which also correspond approximately to the brake pressures on the brake cylinder when the pneumatic connection is formed. Precise knowledge of the brake pressures applied to the respective brake cylinder can be an input variable for an ABS system, for example, or can be used to better assess the current status of the pneumatic system.

The brake pressures controlled by the pressure modulator and the brake pressures acting on the respective brake cylinder are only identical after a certain period of time, wherein this period of time substantially depends on the length of the pneumatic line system and the air flow resistances within the pneumatic line system. Both the length of the pneumatic line system and the air flow resistances that occur are characteristic variables that are characteristic of the respective braking system. The air flow resistances are determined, for example, by the surface roughness of the installed components, throttles, volume sizes, pipe lengths and other variables. While the length of the pneumatic line system remains constant during the service life of the vehicle, the air flow resistances change due to ageing effects. This must be taken into account in order to estimate the condition of the pneumatic system.

To determine the air flow resistances characteristic of the braking system, it is necessary to manually determine air flow resistance values for individual portions of a braking system and then manually enter them into a brake control system. This is very time-consuming due to the manual work required and there is the disadvantage that ageing effects occurring in braking systems, which sometimes have serious influences on the air flow resistances of a braking system, cannot be taken into account or can only be taken into account to a limited extent, as continuous manual determination is not possible.

### SUMMARY

It is an object of the present disclosure to provide a method for determining flow resistance characteristic variables via which the condition of the pneumatic braking system can be determined.

This object is, for example, achieved according to the disclosure by a method for determining a flow resistance characteristic variable in an electropneumatic braking system of a vehicle according to the disclosure.

According to the disclosure, a method for determining a flow resistance characteristic variable in an electro-pneumatic braking system of a vehicle is thus provided, wherein the braking system has at least:
an axle modulator, for example a front-axle axle modulator (for example, single-channel) or a rear-axle axle modulator (for example, multi-channel) with
an axle modulator inlet valve for pressurizing a pressure line connected to at least one working connection of the respective axle modulator with compressed air from a compressed air reservoir connected to the axle modulator via a supply line,
an axle modulator outlet valve for venting the pressure line via an axle modulator outlet, and
a pressure sensor which is configured to determine a pressure value assigned to the respective pressure line; and
at least one service brake or service brake cylinder connected to the pressure line,
the method including the following steps,
determining or recording a first pressure value via the pressure sensor of the axle modulator, while the axle modulator is connected in a pressure-conducting manner or fluidically to the at least one service brake via the working connection and via the pressure line and the axle modulator is brought into a pressure maintaining position, that is, the axle modulator inlet valve and the axle modulator outlet valve are closed in order to hold the actuated brake pressure, so that the brake pressure actuated by the axle modulator and recorded by the pressure sensor also acts on the respective service brake after a certain time;
generating a pressure pulse in the pressure line at a first time;
determining a second pressure value via the pressure sensor of the axle modulator at a second time after the pressure pulse has been generated; and
determining a flow resistance characteristic variable for a flow path within the braking system, wherein the generated pressure pulse propagates within this flow path depending on a change over time of the second pressure value compared to the first pressure value.

A pressure pulse is understood to be a (pulse-like) change in the brake pressure in the respective pressure line or the respective portion of the pressure line or the respective flow path, wherein the brake pressure is either increased or reduced by the (pulse-like) change. Preferably, a pulse-like pressure change is generated at the first time and the resulting pneumatic reaction in the respective flow path is evaluated in time at the second time in order to determine the flow resistance characteristic variable as a measure of the air flow resistance of the respective flow path. This pulse-like pressure change takes place at a first time, so that the recorded or determined first pressure value is still present in the pressure line for a short time at the first time and the pressure is subsequently changed accordingly. The pressure pulse can be generated in various ways, which are described in more detail in the further embodiments as individual pressure pulse steps.

In order to ensure that the brake pressure acting on the service brake has equalized with the brake pressure controlled by the axle modulator when determining or recording the first pressure value, the first pressure value is preferably determined after a corresponding time delay after the last actuation of the axle modulator inlet valve and/or axle modulator outlet valve, so that it can be assumed that the pressure value prevailing in the pressure line is actually approximately constant over the entire length.

After the first time and/or after the pressure pulse has been generated, a second pressure value is recorded at a second time, preferably when the pressure value prevailing in the pressure line is not yet constant over the entire length of the respective flow path, that is, has not yet equalized over the entire length. This second pressure value will be greater than the first pressure value in the case of a pressure pulse generated by an increase in pressure, while the second pressure value will be less than the first pressure value in the case of a pressure pulse generated by a decrease in pressure. The flow resistance characteristic variable can then be determined from the time curve between the first pressure value and the second pressure value, which follows, for example, from the pressure gradient between the first pressure value and the second pressure value, for example from a quotient of (p2−p1) and (t2−t1).

It is also preferable that the second pressure value is also determined while the axle modulator is connected to the at least one service brake via the working connection and via the pressure line in a pressure-conducting or fluidic manner and the axle modulator is set to a pressure maintaining position. The same state is therefore set as when recording the first pressure value in order to compare both values and to be able to estimate the proportion that falls on the flow resistance.

The underlying principle is that a pressure pulse is generated at one point in the pressure line or flow path and the air only flows within the pressure line or flow path after a time delay. The time delay depends on the length of the pressure line or flow path and any ageing effects or the current condition of the pressure lines and pneumatic components. By observing the respective pressure values over time, it is therefore possible to determine the flow resistance characteristic variable of the relevant flow path as a measure of the air flow resistance and also its change over time. Over time, for example, the cross-section of the pressure line can become clogged and thus change or other ageing effects can occur, which results in a change in the flow resistance characteristic variable.

For example, a defined pressure pulse can be generated at regular intervals at a specified first pressure value at the first time, and the second pressure value can always be determined at the same second time (in relation to the first time). If this second pressure value changes over time, the flow resistance characteristic variable also changes, as the time curve between the first and second pressure value changes. In this way, it can be concluded that the pressure line or the respective flow path is ageing. Alternatively, it is also possible to determine at which second time, starting from a fixed first time and a fixed first pressure value, a fixed second pressure value is reached. If the second time changes in different measurements, this indicates a change in the flow resistance characteristic variable, for example due to ageing effects. Here too, the time curve between the (specified) first and the (specified) second pressure value has changed. However, the flow resistance characteristic variable can also be determined and monitored by freely selecting the points in time and pressure values, in particular from the pressure gradient.

Using the method according to the disclosure, it is thus possible to monitor or estimate the air flow resistances of an electropneumatic braking system, which change over time, on the basis of changing flow resistance characteristic variables and thus take the condition into account accordingly during operation of the braking system. Manual determination and input can also be omitted, as the air flow resistances can be estimated on the basis of the determined flow resistance characteristic curve and used in the braking system.

The pneumatic components required to carry out the method are already present in a vehicle with an electropneumatic braking system both on the front axle and on the rear axle, so that no further pneumatic components need to be installed to carry out the method according to the disclosure. It is only necessary to adapt the software in the respective control unit (ECU) in order to control the individual pneumatic components accordingly. The method according to the disclosure can therefore be used to determine a flow resistance characteristic variable for the pressure lines and pneumatic components at any point in the braking system.

Preferably, the pressure pulse is generated by setting a pressure build-up position of the axle modulator and/or by opening an axle modulator inlet valve while the axle modulator outlet valve is closed. This results in a pressure pulse that is conducted, for example, through a flow path (see first or fifth flow path), which includes the pressure line connected to the respective axle modulator via the working connection, a supply line between a compressed air reservoir and the respective axle modulator as well as pneumatic components within the respective pneumatically controlled service brake and within the axle modulator, in particular the axle modulator inlet valve. If there is also an ABS valve in the pressure line, for example on a front axle, the flow path also includes this ABS valve, as the pressure pulse then also flows through it.

Setting the pressure build-up position of the axle modulator is a simple way of generating a pressure pulse, wherein compressed air from the respective compressed air reservoir is introduced into the compressed air line by opening the axle modulator inlet valve, which leads to a pulse-like increase in the pressure value in the pressure line and thus to a pressure pulse. This method for generating the pressure pulse is suitable for both a rear-axle axle modulator with integrated ABS function and a front-axle axle modulator with downstream ABS valves in the pressure line.

The air flow resistances occurring in the flow paths can also be direction-dependent, for example due to throttles and constrictions which contribute differently to the air flow resistance depending on the direction of flow. By setting the pressure build-up position of the axle modulator as described above, a flow resistance characteristic variable can be determined which is relevant when the pressure is applied, that is, when the brakes are applied, so that this can be taken into account accordingly when the brakes are operated when the pressure is increased.

According to a further embodiment of the method, it is preferably provided that the pressure pulse is generated by setting a pressure reduction position of the axle modulator and/or by opening the axle modulator outlet valve while the axle modulator inlet valve is closed. This results in a pressure pulse which is conducted, for example, through a flow path (see second or sixth flow path) which includes the pressure line connected to the respective axle modulator via the working connection as well as pneumatic components within the respective pneumatically actuated service brake and within the axle modulator, in particular the axle modulator outlet valve and an axle modulator outlet. If there is also an ABS valve in the pressure line, for example on a front axle, the (second) flow path also includes this ABS valve, as the pressure pulse then also flows through it.

Opening the axle modulator outlet valve vents the pressure line, which leads to a pulse-like reduction in the pressure value in the pressure line and thus also to a pressure pulse. This makes it possible to determine a flow resistance characteristic variable that is relevant when bleeding, that is, when releasing the brakes, so that this can be taken into account accordingly when operating the brakes if the brake pressure is reduced.

According to a further embodiment of the method, it is preferably provided that the braking system further has an ABS valve arranged in the respective pressure line, including:
an ABS inlet valve for pressurizing an intermediate portion between the ABS valve and the respective service brake with compressed air from the respective pressure line, and
an ABS outlet valve for venting the intermediate portion via an ABS outlet,
wherein the first pressure value is determined while the ABS valve in the respective pressure line is set to a pressure build-up position and the pressure pulse is generated while the axle modulator is set to the pressure maintaining position. As a result, a pressure pulse can be generated which is, for example, conducted through a flow path which includes the pressure line connected to the respective axle modulator via the working connection completely (third flow path) or at least partially (fourth flow path), the respective ABS valve, in particular the ABS outlet valve, the ABS inlet valve and an ABS valve outlet, as well as pneumatic components within the respective pneumatically actuated service brake.

In this structure, the pressure pulse can be generated in different ways with an ABS valve, wherein it is preferably provided that:
the pressure pulse is generated by setting a first pressure reduction position of the ABS valve in the respective pressure line, wherein in the first pressure reduction position the ABS outlet valve of the ABS valve is open and the ABS inlet valve of the ABS valve is or becomes closed (fourth flow path), or
the pressure pulse is generated by setting a second pressure reduction position of the ABS valve, wherein in the second pressure reduction position the ABS outlet valve and the ABS inlet valve of the ABS valve in the respective pressure line are both open or become open (third flow path).

Both variants represent a way of generating a pressure pulse, for example on a front axle with an ABS valve connected downstream of the axle modulator. The recording of the first pressure value when the ABS inlet valve is open therefore takes place while the axle modulator is connected to the respective service brake via the pressure line in a pressure-conducting manner. It is particularly advantageous that the specified venting position of the ABS valve generates a pressure pulse which also propagates in an intermediate portion between the ABS valve and the respective service brake, so that the method according to the disclosure can also be used to determine a flow resistance characteristic variable which represents this intermediate portion. Knowledge of this flow resistance characteristic variable is of interest, for example, when the ABS valve is actuated as part of an ABS control system, in which this intermediate portion is also passed through during venting, so that it is possible to estimate the exact state of the braking system during such an ABS control system by knowing the flow resistance characteristic variable.

Preferably, it is further provided that the second pressure value is determined after the pressure pulse has been generated at the second time, while the ABS outlet valve of the respective ABS valve is closed or after the ABS outlet valve of the respective ABS valve has been closed, and the ABS inlet valve of the ABS valve is open or after the ABS inlet valve of the ABS valve has been opened. To record the second pressure value, after the pressure pulse has been generated, the state is set again as when recording the first pressure value, that is, the respective ABS valve is set to the pressure build-up position so that the axle modulator is fluidically connected to the service brakes.

In any embodiment, it may preferably be provided that the pressure value is determined continuously via the respective pressure sensor. This enables a large number of points in time and pressure values assigned to them to be available, from which a second time and a second pressure value can then be selected, from which the flow resistance characteristic variable then follows. This can improve the accuracy and reliability of the determination.

According to an embodiment compatible with all embodiments of the method, the determined flow resistance characteristic variables are stored in a non-volatile memory.

This enables observation and comparison with historical data, so that current specific flow resistance characteristic variables can be compared with previous values, which in turn allows conclusions to be drawn about signs of ageing. Thanks to the non-volatile memory, the flow resistance characteristic variables are available even after the vehicle has been restarted or is otherwise de-energized.

### BRIEF DESCRIPTION OF DRAWINGS

The invention will now be described with reference to the drawings wherein:

FIG. 1 shows a view of an electropneumatic braking system of a vehicle;

FIG. 2 shows a schematic view of the braking system shown in FIG. 1 on a front axle;

FIG. 3 shows the braking system from FIG. 2 during the execution of a filling step;

FIG. 4 shows the braking system from FIG. 2 during the execution of a recording step;

FIG. 5A shows the braking system from FIG. 2 during the execution of a first pressure pulse step;

FIG. 5B shows the braking system from FIG. 2 during the execution of a second pressure pulse step;

FIG. 5C shows the braking system from FIG. 2 during the execution of a third pressure pulse step;

FIG. 5D shows the braking system from FIG. 2 during the execution of a fourth pressure pulse step;

FIG. 6 shows the sequence of a method for determining a flow resistance characteristic variable;

FIG. 7 shows a schematic view of the braking system from FIG. 1 on a rear axle;

FIG. 8 shows the braking system from FIG. 7 during a fifth pressure pulse step; and,

FIG. 9 shows the braking system from FIG. 7 during a sixth pressure pulse step.

### DETAILED DESCRIPTION

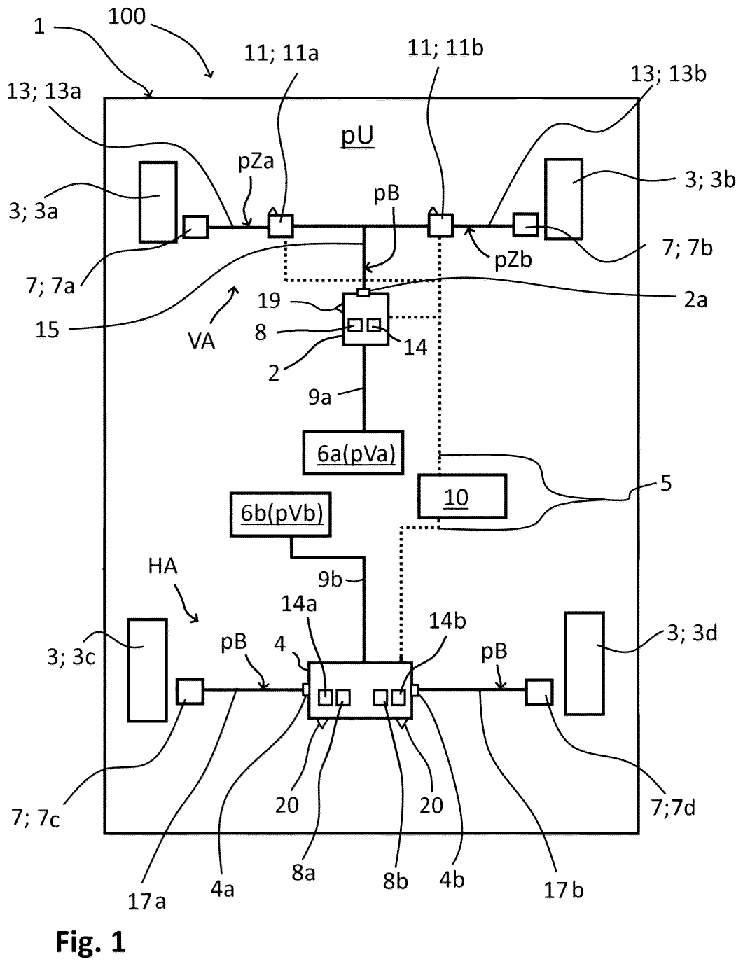

FIG. 1 shows a vehicle 1 with an electropneumatically operated braking system, which can be controlled via a control unit 10 via electrical lines 5. The control of a brake pressure pB on service brakes 7 of wheels 3 on a front axle VA of the vehicle 1, that is, for example on a left service brake 7a on the left front wheel 3a and on a right service brake 7b on the right front wheel 3b, takes place via a front-axle axle modulator 2, which is configured as a single-channel axle modulator. This means that the brake pressure pB controlled by the front-axle axle modulator 2 is controlled equally at the front axle VA from a working connection 2a via a branching pressure line 15 to both service brakes 7a, 7b on the front axle VA. The brake pressure pB generated by the front-axle axle modulator 2 is specified by a specific brake request, wherein the brake request can be generated automatically (by an assistance system) or manually (by the driver).

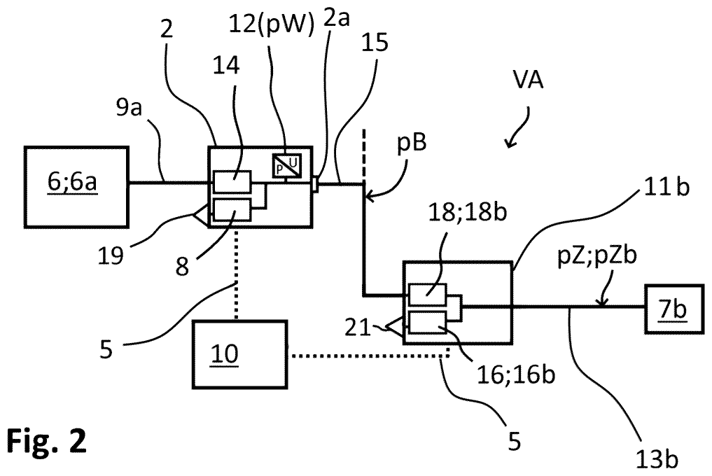

A corresponding axle modulator inlet valve 14 and an axle modulator outlet valve 8 are provided to generate the brake pressure pB in the front-axle axle modulator 2 and can modulate a first supply pressure pVa provided from a first compressed air reservoir 6a via a first supply line 9a into the pressure line 15 as brake pressure pB in the usual manner when activated accordingly. The controlled brake pressure pB can be measured via a pressure sensor 12 arranged in the front-axle axle modulator 2 upstream of the working connection 2a, as shown in FIG. 2. In this way, pressure control can take place in the pressure line 15, in which the brake pressure pB measured by the pressure sensor 12 is controlled accordingly in an actual/setpoint adjustment (closed loop). In this way, a desired braking effect can be set.

An ABS valve 11 is arranged in the pressure line 15 between the front-axle axle modulator 2 and the service brakes 7a, 7b on the respective front wheel 3a, 3b, that is, a left-hand ABS valve 11a and a right-hand ABS valve 11b. Each ABS valve 11 has an ABS inlet valve 18 and an ABS outlet valve 16 (see FIG. 2) in the usual manner, that is, a left-hand ABS inlet valve 18a and a left-hand ABS outlet valve 16a on the left-hand ABS valve 11a and a right-hand ABS inlet valve 18b and a right-hand ABS outlet valve 16b on the right-hand ABS valve 11b, in order to maintain or reduce the brake pressure pB transmitted via the pressure line 15 to the service brakes 7a, 7b as part of an ABS control.

Activation of the respective ABS valve 11 (ABS control) therefore means that the brake pressure pB prevailing in the pressure line 15 is no longer applied directly to the respective service brake 7a, 7b of the front axle VA, at least for a short time, as the pneumatic connection is interrupted or influenced by the ABS valve 11. In an intermediate portion 13 (left intermediate portion 13a, right intermediate portion 13b) of the pressure line 15 between the respective ABS valve 11 and the respective service brake 7a, 7b on the front axle VA, there is therefore an intermediate pressure pZ that cannot be determined or measured directly with the pressure sensor 12 in the front-axle axle modulator 2. As the ABS valves 11 can be controlled individually for each side, this intermediate pressure pZ (left intermediate pressure pZa, right intermediate pressure pZb) can also vary from side to side.

On the rear axle HA there is a left service brake 7c on the left rear wheel 3c and a right service brake 7d on the right rear wheel 3d. The brake pressure pB for the service brakes 7c, 7d on the rear wheels 3c, 3d is controlled via a rear-axle axle modulator 4, which is configured as a multi-channel axle modulator. This means that the brake pressure pB controlled by the rear-axle axle modulator 4 is controlled individually from a left and a right-hand working connection 4a, 4b of the rear-axle axle modulator 4 via a left and a right pressure line 17a, 17b to the service brakes 7c, 7d on the rear wheels 3c, 3d. The brake pressure pB generated by the rear axle pressure modulator 4 is also specified by a brake request, in normal driving mode preferably by the same brake request that is also specified for the front axle pressure modulator 2.

To generate the brake pressure pB in the rear-axle axle modulator 4, corresponding left and right axle modulator inlet valves 14a, 14b and left and right axle modulator outlet valves 8a, 8b are provided, which, when actuated accordingly, each modulate a second supply pressure pVb provided from a second compressed air reservoir 6b via a second supply line 9b correspondingly individually as brake pressure pB via the left and right-hand working ports 4a, 4b of the rear-axle axle modulator 4 into the left and right pressure lines 17a, 17b respectively, wherein the brake pressure pB of the left brake cylinder 7c is modulated via the left axle modulator inlet valve 14a and the left axle modulator outlet valve 8a and the brake pressure pB of the right brake cylinder 7d is modulated via the right axle modulator inlet valve 14b and the right axle modulator outlet valve 8b. The modulated brake pressure pB can be measured individually via left and right pressure sensors 12a, 12b arranged in the rear-axle axle modulator 4 upstream of the working connections 4a and 4b. In this way, individual pressure control can take place in the left and right pressure lines 17a, 17b, in which the brake pressure pB measured by the respective pressure sensor 12a, 12b is controlled accordingly in an actual/setpoint adjustment (closed loop). In this way, a desired braking effect can be set.

The rear-axle axle modulator 4 is therefore a multi-channel axle modulator with a first channel (left inlet valve 14a, left-hand working port 4a, left exhaust valve 8a) and a second channel (right inlet valve 14b, right-hand working port 4b, right exhaust valve 8b). The function of an ABS valve can be integrated into the rear-axle axle modulator 4 by opening and closing the inlet valves 14a, 14b and outlet valves 8a, 8b of the rear-axle axle modulator 4 depending on the recorded wheel speeds or wheel slippage, wherein the service brakes 7c, 7d on the rear axle HA can also be pneumatically controlled differently for each side.

FIG. 2 schematically shows only the front axle VA of the braking system 100 described, wherein only the portion from the first compressed air reservoir 6a via the front-axle axle modulator 2 and the right-hand ABS valve 11b to the right-hand service brake 7b is shown. Inside the front-axle axle modulator 2, the pressure sensor 12 is arranged such that, irrespective of the position of the axle modulator inlet valve 14 and the axle modulator outlet valve 8, a pressure value pW can be measured by the pressure sensor 12 in the front-axle axle modulator 2, which corresponds to or represents the brake pressure pB prevailing in the pressure line 15 at the front axle VA at least up to the right-hand ABS valve 11b.

The axle modulator inlet valve 14 and the axle modulator outlet valve 8 in the front-axle axle modulator 2 can both be closed, as is sufficiently well known, in order to bring the front-axle axle modulator 2 into a “pressure maintaining position” PX1, in which the first supply pressure pVa provided by the first compressed air reservoir 6a is not emitted into the pressure line 15 at the front axle VA. The brake pressure pB in the pressure line 15 at the front axle VA is thus maintained. In a “pressure reduction position” PX2 (axle modulator inlet valve 14 closed and axle modulator outlet valve 8 open), the pressure line 15 behind the working connection 2a of the front-axle axle modulator 2 is vented, which reduces the controlled brake pressure pB or brings it closer to an ambient pressure pU. In a “pressure build-up position” PX3 (axle modulator inlet valve 14 open and axle modulator outlet valve 8 closed), the front-axle axle modulator 2 allows the first supply pressure pVa provided by the first compressed air reservoir 6a to pass unhindered into the pressure line 15 behind the working connection 2a of the front-axle axle modulator 2, so that the brake pressure pB applied to the front axle VA increases.

The front-axle axle modulator 2 is controlled by the control unit (ECU) 10 via electrical control lines 5 in order to set the respective position PX1, PX2, PX3.

The right-hand ABS valve 11b on the front axle VA has four possible positions due to specific control of the right-hand ABS inlet valve 18b and the right-hand ABS outlet valve 16b. In a “pressure maintaining position” PA1, the right-hand ABS inlet valve 18b and the right-hand ABS outlet valve 16b are closed, so that the brake pressure pB controlled via the working connection 2a of the front-axle axle modulator 2 is not controlled in the right-hand intermediate portion 13b. The right intermediate pressure pZb is thus maintained. In a “pressure build-up position” PA3 (right-hand ABS inlet valve 18b open and right-hand ABS outlet valve 16b closed), the right-hand ABS valve 11b allows the brake pressure pB controlled via the working connection 2a of the front-axle axle modulator 2 to pass unhindered into the right-hand intermediate portion 13b and thus to the right-hand service brake 7b on the right-hand front wheel 3b. The right intermediate pressure pZb can therefore adapt to the brake pressure pB controlled via the working connection 2a of the front-axle axle modulator 2.

In a first “pressure reduction position” PA2a (right-hand ABS inlet valve 18b closed and right-hand ABS outlet valve 16b open), the right intermediate portion 13b is vented via the right-hand ABS outlet valve 16b, reducing the right intermediate pressure pZb or bringing it closer to an ambient pressure pU. In a second “pressure reduction position” PA2b (right-hand ABS inlet valve 18b open and right-hand ABS outlet valve 16b open), the pressure line 15 behind the working connection 2a of the front axle pressure modulator 2, including the right-hand intermediate portion 13b, is vented, which reduces both the right-hand intermediate pressure pZb and the brake pressure pB or brings it closer to an ambient pressure pU, which in this case can also be measured by the pressure sensor 12 in the front axle pressure modulator 2. The right-hand ABS valve 11b is actuated via the control unit 10. The left-hand ABS valve 11a can also be actuated in the same way in order to set the four aforementioned positions PA1, PA2a, PA2b, P3 in the respective situation.

The part of the braking system 100 on the front axle VA shown in FIG. 2 is suitable for carrying out all the embodiments or steps of the method according to the disclosure described below, since the respective ABS valve 11a, 11b on the front axle VA can be brought into the described second “pressure reduction position” PA2b.

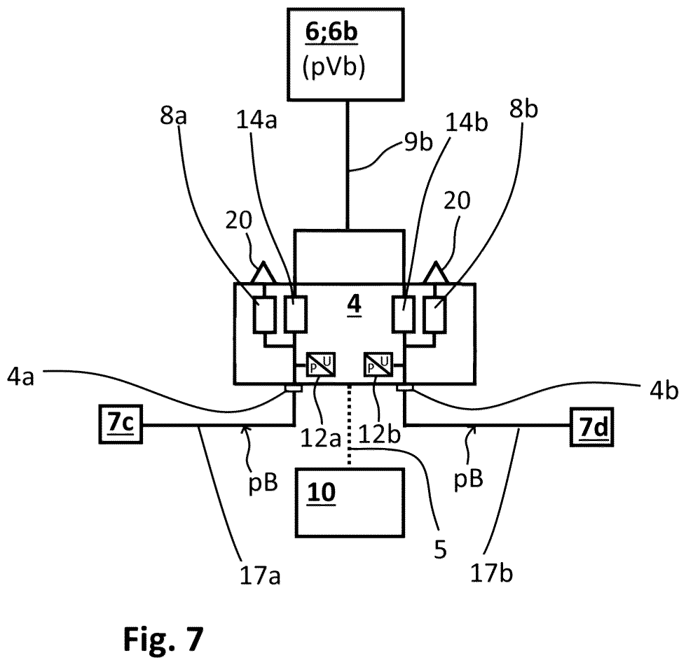

FIG. 7 schematically shows only the rear axle HA of the braking system 100, wherein the portion from the second compressed air reservoir 6b via the multi-channel rear-axle axle modulator 4 to the service brakes 7c and 7d on the rear axle HA is shown. The multi-channel rear-axle axle modulator 4 is characterized by the first channel, formed by the left axle modulator inlet valve 14a, the left-hand working connection 4a and the left axle modulator outlet valve 8a, which pneumatically controls the left service brake 7c on the rear axle HA via the left pressure line 17a, and the second channel, formed by the right axle modulator inlet valve 14b, the right-hand working connection 4b and the right axle modulator outlet valve 8b, which controls the right service brake 7d on the rear axle HA via the right pressure line 17b.

Inside the rear-axle axle modulator 4, the left and right pressure sensors 12a, 12b are arranged in such a way that, irrespective of the position of the left or right axle modulator inlet valve 14a, 14b and the left or right axle modulator outlet valve 8a, 8b, an individual pressure value pW can be measured by the respective pressure sensor 12a, 12b in the respective channel, which corresponds to the brake pressure pB prevailing in the left or right pressure line 17a, 17b on the rear axle HA.

Possible positions PX1, PX2, PX3 of the multi-channel rear-axle axle modulator 4 correspond here to the positions PX1, PX2, PX3 of the single-channel front-axle axle modulator 2 in FIG. 2, with the only difference that independent control (per channel) is possible on each side. The rear-axle axle modulator 4 is also controlled by the control unit (ECU) 10 via electrical control lines 5.

The part of the braking system 100 on the rear axle HA shown in FIG. 7 is suitable for carrying out at least some of the embodiments or steps of the method according to the disclosure described below.

In the context of certain assistance functions, for example steer-by-brake, ESP, et cetera, knowledge of the air flow resistances is advantageous in order to better assess the current state of the pneumatic system. The air flow resistances occurring in the pressure lines 15, 17a, 17b and pneumatic components of the braking system 100 can be direction-dependent, for example due to throttles and bottlenecks, which contribute differently to the overall air flow resistance depending on the direction of flow. The background is that the air in an individual flow path Pi within the braking system 100 is exposed to a certain air flow resistance, which is particularly dependent on a surface roughness of the installed components in the respective flow path Pi, on throttles in the respective flow path Pi, on volume sizes of the respective flow path Pi, on pipe lengths of the pressure lines 15, 17a, 17b involved, the flow direction of the air and other influences that act on the air in the respective flow path Pi.

Various flow paths Pi (i=1, 2, 3, 4, 5, 6) are therefore considered below, through which the air flows during operation of the braking system 100 depending on the actuation of the pneumatic components, wherein the flow paths Pi considered in each case are shown schematically as dashed lines in the figures described below. Via various embodiments of the method, path-specific flow resistance characteristic variables RLi (i=1, 2, 3, 4, 5, 6) can be determined, which characterize the air flow resistance in the respective flow path Pi or which allow conclusions to be drawn about the air flow resistance in the respective flow path Pi.

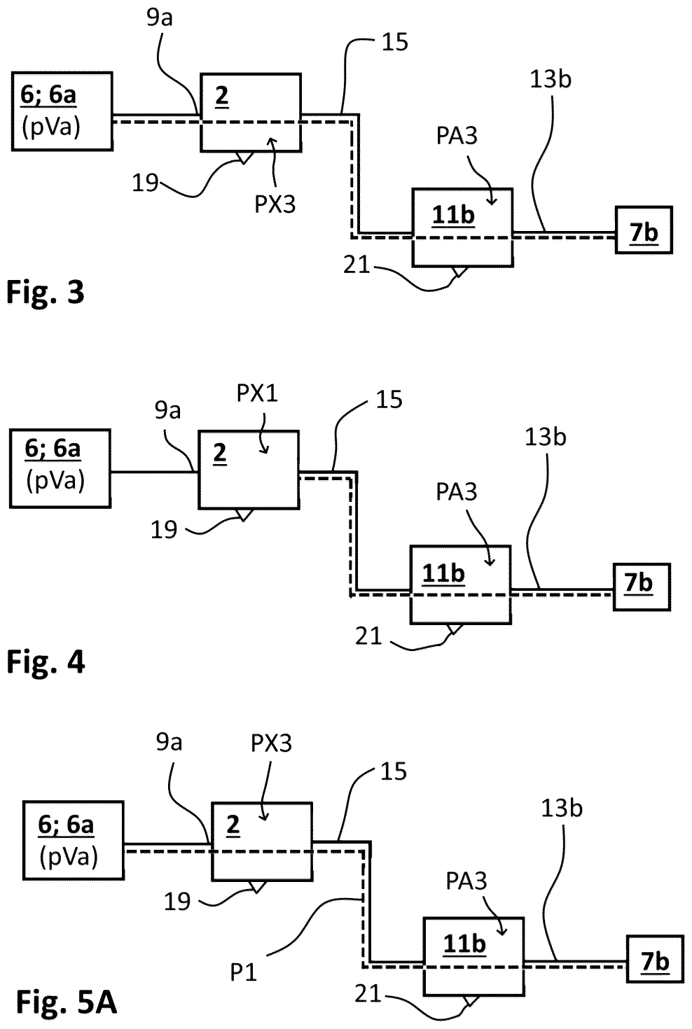

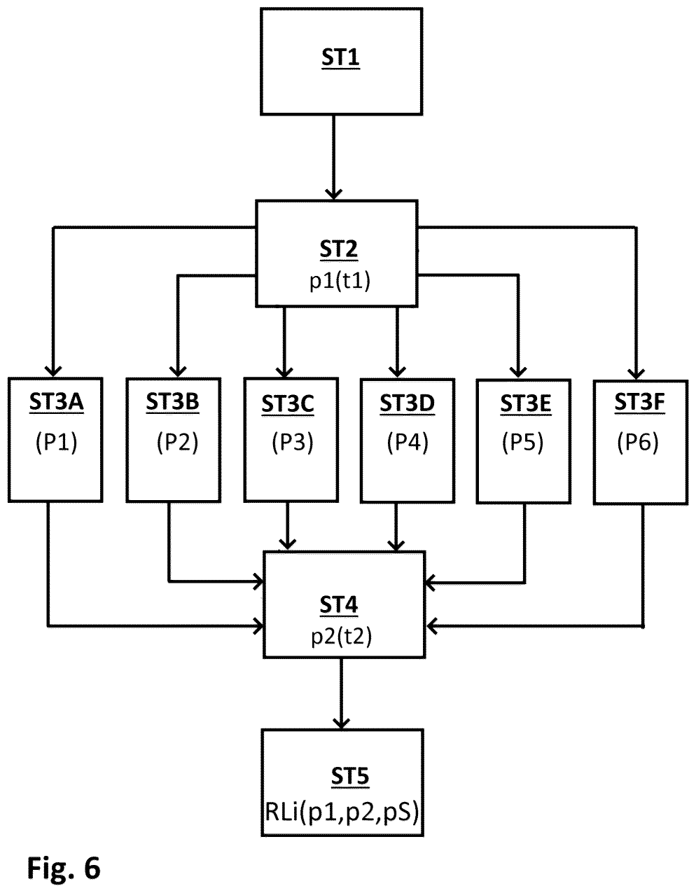

The method shown in FIG. 6 for determining such a flow resistance characteristic variable RLi is explained in more detail below using FIGS. 3, 4, 5A, 5B, 5C, 5D as examples for different flow paths Pi (i=1, 2, 3, 4, 5, 6) on the front axle VA of the vehicle 1, that is, with ABS valves 11; 11a, 11b in the pressure line 15, or on the rear axle HA, that is, without ABS valves 11. In the aforementioned figures, only the right-hand part of the front axle VA and the rear axle HA are shown by way of example (comparably to FIG. 2 and FIG. 7):

FIG. 3 shows a filling step ST1 of the method for determining a flow resistance characteristic variable RLi. In the filling step ST1, the pressure line 15 of the front axle VA of the braking system 100 is at least temporarily filled with compressed air from the first compressed air reservoir 6a, wherein the front-axle axle modulator 2 is moved to the “pressure build-up position” PX3 and the right-hand ABS valve 11b is also moved to the “pressure build-up position” PA3, so that the brake pressure pB applied to the working connection 2a of the front-axle axle modulator 2 acts via the pressure line 15 including the right intermediate portion 13b on the right service brake 7b of the right front wheel 3b.

The filling step ST1 does not have to be a separate method step, but can also take place during operation of the braking system, for example when the pressure line 15 or the right intermediate portion 13b on the front axle is pressurized with a correspondingly modulated brake pressure pB from the first compressed air reservoir 6a due to an (automatic or manual) brake request. The purpose of the filling step ST1 is therefore to ensure that a brake pressure pB that is higher than an ambient pressure pU prevails in the pressure line 15 on the front axle VA to the right service brake 7b of the right front wheel 3b by specifically setting the respective “pressure build-up positions” PX3, PA3. As will be explained below, the filling step ST1 is optional in some embodiments of the method.

FIG. 4 shows a first recording step ST2, in which a first pressure value p1 is recorded as the pressure value pW via the pressure sensor 12 arranged in the front-axle axle modulator 2 (see also FIG. 2), while the front-axle axle modulator 2 is connected to the right-hand service brake 7b on the right-hand front wheel 3b via the pressure line 15 in a pressure-conducting manner. The front-axle axle modulator 2 is set to the “pressure maintaining position” PX1 and the right-hand ABS valve 11b is set to the “pressure build-up position” PA3. In the first recording step ST2, a first pressure value p1 is therefore measured, which is set between the front-axle axle modulator 2 and the right-hand service brake 7b on the right-hand front wheel 3b. Based on this, the following pressure pulse steps ST3 are provided:

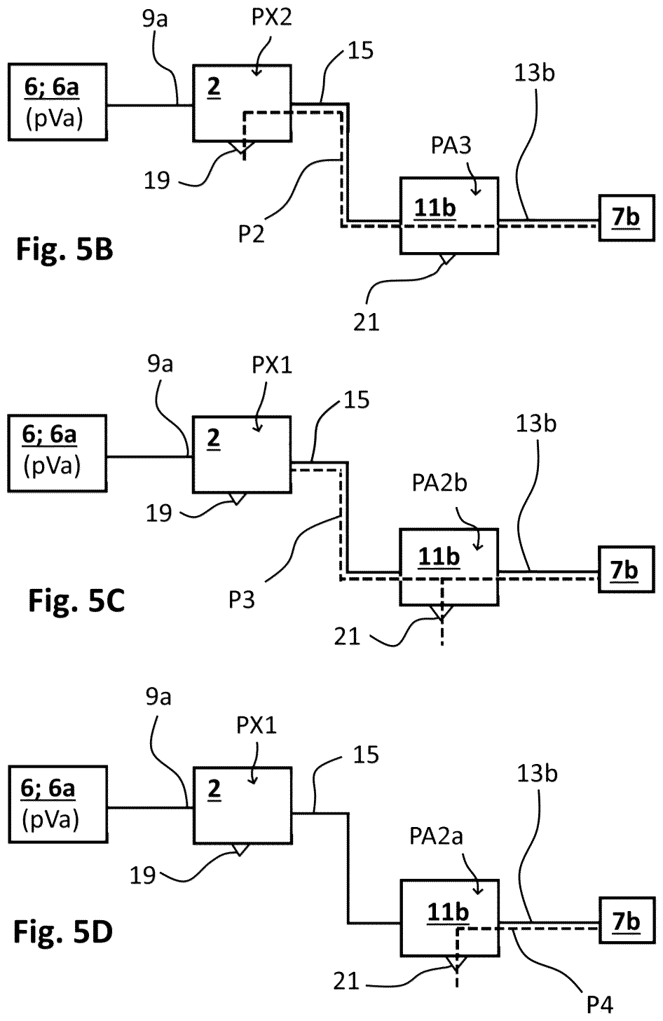

FIG. 5A shows a first pressure pulse step ST3A for a first flow path P1. The first flow path P1 includes the pressure line 15 including the right intermediate portion 13b, the right-hand ABS valve 11b, a first supply line 9a between the first compressed air reservoir 6a and the front-axle axle modulator 2, as well as pneumatic components within the right service brake 7b on the right front wheel 3b and within the front-axle axle modulator 2, in particular the axle modulator inlet valve 14. In the first pressure pulse step ST3A, a pressure pulse is generated in the pressure line 15 at a first time t1 by setting the “pressure build-up position” PX3 of the front-axle axle modulator 2, wherein the right-hand ABS valve 11b also remains unchanged in the “pressure build-up position” PA3. In the first pressure pulse step ST3A, there is therefore a further increase in the brake pressure pB controlled by the working connection 2a of the front-axle axle modulator 2, which from here spreads along the pressure line 15 on the front axle VA via the right-hand ABS valve 11b into the right-hand intermediate portion 13b up to the right-hand service brake 7b.

The same applies to the left-hand part of the braking system 100 on the front axle VA.

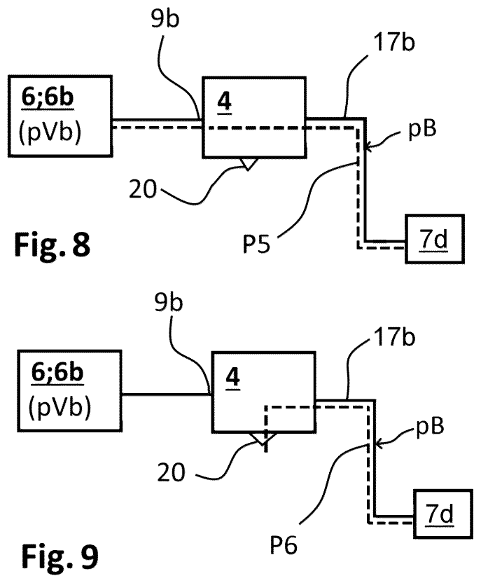

FIG. 8 analogously shows a fifth pressure pulse step ST3E for a fifth flow path P5, wherein, as shown in FIG. 7, this is a pressure pulse in the right pressure line 17b of the right channel of the rear axle pressure modulator 4, in which no ABS valve is arranged. The fifth flow path P5 therefore includes the right-hand pressure line 17b, a second supply line 9b between the second compressed air reservoir 6b and the rear axle pressure modulator 4, as well as pneumatic components within the right-hand service brake 7d on the right-hand rear wheel 3d and within the rear axle pressure modulator 4, in particular the right-hand axle pressure modulator inlet valve 14b. The pressure pulse is otherwise generated in the same way as described for the front axle VA in FIG. 5A by setting the “pressure build-up position” PX3 of the rear-axle axle modulator 4 for the respective channel. These explanations apply analogously to the left-hand part of the braking system 100 on the rear axle HA, that is, the other channel of the rear-axle axle modulator 4.

Before the first and fifth pressure pulse steps ST3A, ST3E, the filling step ST1 is optional, since the pressure pulse can increase the brake pressure pB in the respective pressure line 15, 17a, 17b in any case, which can also occur based on the ambient pressure pU.

FIG. 5B shows a second pressure pulse step ST3B for a second flow path P2. The second flow path P2 includes the pressure line 15 on the front axle VA including the right intermediate portion 13b, the right-hand ABS valve 11b, as well as pneumatic components within the right service brake 7b on the right front wheel 3b and within the front-axle axle modulator 2, in particular the axle modulator outlet valve 8 and a front-axle axle modulator outlet 19, through which air can escape. In the second pressure pulse step ST3B, a pressure pulse is generated at a first time t1 in the pressure line 15 of the front axle VA including the right intermediate portion 13b by setting the “pressure reduction position” PX2 of the front-axle axle modulator 2, wherein the right-hand ABS valve 11b remains unchanged in the “pressure build-up position” PA3. In the second pressure pulse step ST3B, the brake pressure pB controlled by the working connection 2a of the front-axle axle modulator 2 is thus reduced in this embodiment, so that air flows from the right-hand service brake 7b via the right-hand intermediate portion 13b, the right-hand ABS valve 11b along the pressure line 15 and via the working connection 2a of the front-axle axle modulator 2 through this into the front-axle axle modulator outlet 19.

FIG. 9 analogously shows a sixth pressure pulse step ST3F for a sixth flow path P6, wherein, as shown in FIG. 7, this is a pressure pulse in the right pressure line 17b of the right channel of the rear axle pressure modulator 4 on the rear axle HA, in which no ABS valve is arranged. The sixth flow path P6 therefore includes the right-hand pressure line 17b as well as pneumatic components within the right-hand service brake 7d on the right-hand rear wheel 3d and within the rear axle pressure modulator 4, in particular the right-hand axle modulator outlet valve 8b and a rear axle pressure modulator outlet 20 through which air can escape. The pressure pulse is otherwise generated in the same way as described for the front axle VA in FIG. 5B, by setting the “pressure reduction position” PX2 of the rear-axle axle modulator 4 for the respective channel. These explanations apply analogously to the left-hand part of the braking system 100 on the rear axle HA, that is, the other channel of the rear-axle axle modulator 4.

FIG. 5C shows a third pressure pulse step ST3C for a third flow path P3. The third flow path P3 includes the pressure line 15 on the front axle VA including the right intermediate portion 13b, the right-hand ABS valve 11b, in particular the ABS outlet valve 16b, the ABS inlet valve 18b and an ABS valve outlet 21, as well as pneumatic components within the right service brake 7b on the right front wheel 3b.

In the third pressure pulse step ST3C, a pressure pulse is achieved in the pressure line 15 and the right intermediate portion 13b at a first time t1 by setting the second “pressure reduction position” PA2b of the right-hand ABS valve 11b, wherein the front-axle axle modulator 2 remains in the pressure maintaining position PX1. This third pressure pulse step ST3C therefore reduces the brake pressure pB in the pressure line 15 at the front axle VA and the intermediate pressure pZb in the right-hand intermediate line 13b, that is, compressed air flows from the working connection 2a of the front-axle axle modulator 2 and from the right-hand service brake 7b in the direction of the right-hand ABS valve 11b and therein through the ABS valve outlet 21 into the environment.

FIG. 5D shows a fourth pressure pulse step ST3D for a fourth flow path P4. The fourth flow path P4 includes the right intermediate portion 13b, the right-hand ABS valve 11b, in particular the ABS outlet valve 16b and the ABS valve outlet 21, as well as pneumatic components within the right service brake 7b on the right front wheel 3b.

In the fourth pressure pulse step ST3D, a pressure pulse is achieved in the right intermediate portion 13b at a first time t1 by setting the first “pressure reduction position” PA2a of the right-hand ABS valve 11b. In contrast to the third pressure pulse step ST3C, the fourth pressure pulse step ST3D therefore only reduces the right-hand intermediate pressure pZb in the right-hand intermediate line 13b, that is, compressed air flows from the right-hand service brake 7b in the direction of the right-hand ABS valve 11b and through the ABS valve outlet 21 into the environment. The front-axle axle modulator 2 remains in the “pressure maintaining position” PX1.

The arrangement and valve position shown in FIGS. 5C and 5D for generating a pressure pulse is only possible on the front axle VA of the braking system 100 shown, that is, if an additional ABS valve 11 is provided in addition to the front-axle axle modulator 2. The third and fourth pressure pulse steps ST3C, ST3D can therefore not be carried out on the rear axle HA of the braking system 100 shown in FIG. 1, as the third and fourth flow paths P3, P4 are not present on the rear axle HA.

Following the respective pressure pulse step ST3A, ST3B, ST3C, ST3D, ST3E, ST3F, a second recording step ST4 takes place at a second time t2, in which a second pressure value p2 is recorded as the pressure value pW via the pressure sensor 12, 12a, 12b arranged in the respective axle modulator 2, 4 (see also FIGS. 2 and 7). As in the first recording step ST2, a second pressure value p2 is measured in the second recording step ST4 and is set between the respective axle modulator 2, 4 and the respective service brake 7. For this purpose, the front-axle axle modulator 2 is set to the “pressure maintaining position” PX1 and the right-hand ABS valve 11b is set to the “pressure build-up position” PA3. It is important here that not too much time elapses between the generation of the respective pressure pulse at time t1 and the second time t2, for example between 50 ms and 100 ms, as the brake pressures pB in the respective pressure line 15, 17a, 17b can otherwise equalize completely, which may falsify the subsequent result.

Then, in a determination step ST5, a flow resistance characteristic variable RLi assigned to the respective flow path Pi to which a pressure pulse was “applied” in the respective pressure pulse step ST3A, ST3B, ST3C, ST3D, ST3E, ST3F is determined from the following relationship depending on the time curve of the brake pressure pB between the first pressure value p1, which is still present at the first time t1 immediately before the pressure pulse is generated, and the second pressure value p2 at the second time t2:

$$RLi ∼ \frac{d p}{d t}$$

In the case of the discrete recording of pressure values p1, p2 at the respective times t1, t2 described above, the simplified relationship results:

$$RLi ∼ \frac{d p}{d t} = \frac{p 2 - p 1}{t 2 - t 1}$$

From this, a flow resistance characteristic variable RLi can be determined for the respective flow path Pi in different ways. In the simplest case, the two points in time t1, t2 can be defined, for example between 50 ms and 100 ms apart, and then the corresponding pressure values p1, p2 present before the respective pressure pulse (t1) and after the respective pressure pulse (t2) can be measured in the respective recording step ST2, ST4. The flow resistance characteristic variable RLi then follows from the above relationship as a measure of the flow resistance, for example, from

$$R L i = \frac{p 2 - p 1}{t 2 - t 1}$$

scaled with an additional factor if necessary.

Alternatively, the times t1, t2 and the first pressure value p1 can also be specified, wherein the first pressure value p1 is specifically set in the filling step ST1. In this case, only the second pressure value p2 measured at the second time t2 changes depending on the flow resistance, influenced by the characteristics of the respective flow path Pi. Taking into account the fact that the parameters t1, t2, p1 of the above formula are fixed and known, the variable second pressure value p2 itself can therefore be assumed to be a flow resistance characteristic variable RLi, that is, a measure of the flow resistance, in this particular case.

Another option is to generate a defined pressure pulse at a fixed first pressure value p1 at the first time t1 and to determine a time period or a second time t2 until the pressure value pW has equalized to a fixed default pressure value pS. The pressure value pW is therefore continuously monitored during the respective pressure pulse step ST3A, ST3B, ST3C, ST3D, ST3E, ST3F until the pressure value pW has reached the default pressure value pS as the second pressure value p2 at the second time t2 to be determined. In this special case, the parameters t1, p1, p2 of the above formula are fixed and known and the variable second time t2 can itself be assumed to be a flow resistance characteristic variable RLi, that is, a measure of the flow resistance.

Therefore, ageing of the pressure lines or the pneumatic components or other impairments in the flow behavior can be inferred if either the second pressure value p2 changes after the predetermined second time t2 compared to previous measurements, or if the second time t2 changes compared to previous measurements until a predetermined second pressure value p2 or default pressure value pS is reached.

In addition, the second time t2 can also be defined as a variable parameter in such a way that this second time t2 is reached when the pressure value pW measured by the respective pressure sensor 12, 12a, 12b no longer changes or remains constant within a tolerance after the respective pressure pulse has been applied. The second pressure value p2 is then specific for the respective pressure pulse and can be determined by a temporal consideration (for example, mathematical derivation) of the measured pressure value pW (if this remains constant within the tolerance). It is assumed that the period of time within which pressure equalization (constant brake pressure pB) takes place in the respective flow path Pi (in this case the period between t1 and t2) is dependent on the flow resistance in the respective flow path Pi, so that this period of time, which is given by the variable second time t2, is also a measure of the flow resistance.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1 vehicle
2 front-axle axle modulator (single-channel)
2a working connection of the front-axle axle modulator 2
3 wheel
3a left front wheel
3b right front wheel
3c left rear wheel
3d right rear wheel
4 rear-axle axle modulator (multi-channel)
4a left-hand working connection of the rear-axle axle modulator 4
4b right-hand working connection of the rear-axle axle modulator 4
5 electrical control lines
6a first compressed air reservoir
6b second compressed air reservoir
7 service brake
7a service brake on left front wheel 3a
7b service brake on right front wheel 3b
7c service brake on left rear wheel 3c
7d service brake on right rear wheel 3d
8 axle modulator outlet valve of the front-axle axle modulator 2
8a left axle modulator outlet valve of the rear-axle axle modulator 4
8b right axle modulator outlet valve of the rear-axle axle modulator 4
9a first supply line
9b second supply line
10 ECU
11 ABS valve
11a left ABS valve
11b right ABS valve
12 pressure sensor
12a left pressure sensor
12b right pressure sensor
13 intermediate portion
13a left intermediate portion
13b right intermediate portion
14 axle modulator inlet valve of the front-axle axle modulator 4
14a left axle modulator inlet valve of the rear-axle axle modulator 4
14b right axle modulator inlet valve of the rear-axle axle modulator 4
15 pressure line of the front axle VA
16 ABS outlet valve
16a left-hand ABS outlet valve
16b right-hand ABS outlet valve
17a left pressure line of rear axle HA
17b right pressure line of rear axle HA
18 ABS inlet valve
18a left-hand ABS inlet valve
18b right-hand ABS inlet valve
19 front-axle axle modulator outlet
20 rear-axle axle modulator outlet
21 ABS valve outlet
100 braking system
HA rear axle
PA1 pressure maintaining position of the ABS valve 11
PA2a first pressure reduction position of the ABS valve 11
PA2b second pressure reduction position of the ABS valve 11
PA3 pressure build-up position of the ABS valve 11
pB brake pressure
pS default pressure value
pU ambient pressure
pVa first supply pressure
pVb second supply pressure
pW pressure value
PX1 pressure maintaining position of the axle modulators 2, 4
PX2 pressure reduction position of the axle modulators 2, 4
PX3 pressure build-up position of the axle modulators 2, 4
pZ intermediate pressure
pZa left intermediate pressure
pZb right intermediate pressure
Pi flow path i, i=1, 2, 3, 4, 5, 6
p1 first pressure value
p2 second pressure value
RLi flow resistance characteristic variable
t1 first time
t2 second time
VA front axle
ST1 filling step
ST2 first recording step
ST3A first pressure pulse step
ST3B second pressure pulse step
ST3C third pressure pulse step
ST3D fourth pressure pulse step
ST3E fifth pressure pulse step
ST3F sixth pressure pulse step
ST4 second recording step
ST5 determination step

1. A method for determining a flow resistance characteristic variable in an electropneumatic braking system of a vehicle, wherein the braking system includes at least:
an axle modulator;
an axle modulator inlet valve for pressurizing a pressure line connected to at least one working connection of the axle modulator with compressed air from a compressed air reservoir connected to the axle modulator via a supply line;
an axle modulator outlet valve for venting the pressure line via an axle modulator outlet;
a pressure sensor configured to determine a pressure value assigned to the respective pressure line; and,
at least one service brake connected to the pressure line; the method comprises the steps of:
determining a first pressure value (p1) via the pressure sensor of the axle modulator, while the axle modulator is connected via the working connection via the pressure line to the at least one service brake in a pressure-conducting manner and the axle modulator is brought into a pressure maintaining position;
generating a pressure pulse in the pressure line at a first time (t1);
determining a second pressure value (p2) via the pressure sensor of the axle modulator at a second time (t2) after the pressure pulse has been generated; and,
determining the flow resistance characteristic variable for a flow path within the braking system, wherein the generated pressure pulse propagates, depending on a change over time of the second pressure value (p2) with respect to the first pressure value (p1).

2. The method of claim 1, wherein the pressure pulse is generated by doing at least one of the following: i) setting a pressure build-up position of the axle modulator; and, ii) opening an axle modulator inlet valve with the axle modulator outlet valve closed at the same time.

3. The method of claim 2, wherein the pressure pulse is thereby conducted through a first flow path or a fifth flow path, which has the pressure line connected to the respective axle modulator via the working connection, the supply line between the respective compressed air reservoir and the respective axle modulator as well as pneumatic components within the respective pneumatically actuated service brake and within the axle modulator including the respective axle modulator inlet valve.

4. The method of claim 1, wherein the pressure pulse is generated by at least one of the following: i) setting a pressure reduction position of the axle modulator; and, ii) opening the axle modulator outlet valve while the axle modulator inlet valve is closed.

5. The method of claim 4, wherein the pressure pulse is thereby conducted through a second flow path or a sixth flow path, which has the pressure line connected to the respective axle modulator via the working connection as well as pneumatic components within the respective pneumatically actuated service brake and within the axle modulator including the respective axle modulator outlet valve.

6. The method of claim 1, wherein the braking system furthermore has an ABS valve arranged in the respective pressure line, comprising:
an ABS inlet valve for pressurizing an intermediate portion between the ABS valve and the respective service brake with compressed air from the respective pressure line; and,
an ABS outlet valve for venting the intermediate portion via an ABS outlet, wherein the first pressure value (p1) is determined while the ABS valve in the respective pressure line is set to a pressure build-up position and the pressure pulse is generated while the axle modulator is set to the pressure maintaining position.

7. The method of claim 6, wherein:
the pressure pulse is generated by setting a first pressure reduction position of the ABS valve in the respective pressure line, wherein in the first pressure reduction position, the ABS outlet valve of the ABS valve is or becomes open and the ABS inlet valve of the ABS valve is or becomes closed; or,
the pressure pulse is generated by setting a second pressure reduction position of the ABS valve, wherein in the second pressure reduction position, the ABS outlet valve and the ABS inlet valve of the ABS valve in the respective pressure line are both open or both become open.

8. The method of claim 7, wherein the pressure pulse is thereby conducted through a third flow path or a fourth flow path, which has the pressure line connected to the respective axle modulator via the working connection completely or at least partially in the respective intermediate portion, the respective ABS valve including the ABS outlet valve, the ABS inlet valve and the ABS valve outlet, as well as pneumatic components within the respective pneumatically actuated service brake.

9. The method of claim 7, wherein the second pressure value (p2) is determined after the pressure pulse has been generated at the second time (t2) while the ABS outlet valve of the respective ABS valve is closed or after the ABS outlet valve of the respective ABS valve has been closed, and the ABS inlet valve of the ABS valve is open or after the ABS inlet valve of the ABS valve has been opened.

10. The method of claim 1, wherein the second pressure value (p2) is determined via the pressure sensor of the axle modulator, while the axle modulator is connected to the at least one service brake via the working connection via the pressure line in a pressure-conducting manner and the axle modulator is brought into a pressure maintaining position.

11. The method of claim 1, wherein the pressure value is determined continuously via the respective pressure sensor.

12. The method of claim 1, wherein the flow resistance characteristic variable is determined from a pressure gradient between the first pressure value (p1) and the second pressure value (p2), wherein the pressure gradient follows from a quotient of (p2−p1) and (t2−t1).

13. The method of claim 1, wherein the determined flow resistance characteristic variables are stored in a non-volatile memory.
